(19) United States
(12) Patent Application Publication
(10) Pub. No.: US 2007/0132842 A1
(43) Pub. Date: Jun. 14, 2007

(54) Video systems for hazardous material environment

(75) Inventor: Joseph Morris, Leesville, SC (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation, Wilmington, DE (US)

(21) Appl. No.: 11/297,961

(22) Filed: Dec. 9, 2005

(51) Int. Cl. H04N 7/18

(52) U.S. Cl. 348/82; 348/143

(57) ABSTRACT

A live video system provides live video monitoring of subject matter in a hazardous zone located in a poor radio frequency (RF) transmission area. A camera sealed against contamination captures video images of the subject matter in the hazardous zone. The camera sends the live video images over a camera cable connected to a live reel. The live reel may be located in the hazardous zone and has a feed cable on the live reel electrically connected to the camera cable as the feed cable is paid out from the live reel. This feed cable extends from the live reel to a transmission station located outside the poor RF transmission area. The transmission station has a RF transmitter connected to the feed cable. The RF transmitter transmits the video signal to a receiving station.

### FIELD OF THE INVENTION

This invention relates to video systems that can be used to view hazardous material environments from a remote location. More particularly, the invention relates to video systems for hazardous material and environments hardened against radio frequencies (RF).

### BACKGROUND OF THE INVENTION

Personnel for hazardous material environmental teams are selected with a variety of subject matter skills so as to deal with multiple types of subject matter in the hazardous environments. However, it is not possible to have a person on the team for each possible subject matter. Therefore, it often occurs that a video system is used to transmit an image of the subject matter in the hazardous material environment, i.e. hazardous zone, outside of the hazardous zone so that a person skilled in the type of subject matter but not skilled in handling hazardous materials can view the situation in the hazardous zone.

In the past this has been accomplished by using a video camera carried by a HAZ-MAT person into the environment to capture the images of the hazardous zone on video media. The video media can then be reviewed later by a skilled person familiar with the subject matter in the hazardous zone.

There are several problems in using a video camera in a hazardous zone. First, the camera needs to be protected from contamination in the hazardous zone or the camera will need to be destroyed and packaged with the contaminated materials when it comes out of the hazardous zone. Second, capturing the images in the hazardous zone on a video recording does not provide a real time viewing of what is happening in the hazardous zone to the person outside the zone who is the most skilled in working with the subject matter and equipment in the zone.

This latter problem can be solved by placing an RF transmitter with the video system in the hazardous zone so that live video is transmitted from the hazardous zone. However, such an implementation may not be operative in certain hazardous material environments. For example, if the hazardous zone is in a building, the RF transmission from the building may be poor and erratic. Further, if the hazardous material is in a room that is designed to be RF-free, i.e. hardened against RF energy, then RF transmissions from the room will be blocked by the room's construction. Also if the hazardous material environment contained radiation sources or other environmental conditions that prevented the transmission of signals by radio frequency or other electromagnetic radiation, then live broadcasting from the hazardous zone is probably not possible.

### SUMMARY OF THE INVENTION

In accordance with this invention the above and other problems have been addressed by a live video system that provides live video monitoring of subject matter in a hazardous zone even when the hazardous zone is located in a poor electromagnetic radiation transmission area. The live video monitoring is provided to a monitor station in a clean zone by using a video camera at the hazardous zone. The camera is resistant to contamination and captures the video images of the subject matter in the hazardous zone. The camera sends the live video images over a camera cable connected to a live reel. The live reel is located also in the hazardous zone and has a feed cable on the live reel electrically connected to the camera cable as the feed cable is paid out from the live reel. This feed cable extends from the live reel to a transmission station located outside the poor electromagnetic radiation transmission area. The transmission station has a transmitter connected to the feed cable. The transmission station receives the video signal over the feed cable and transmits the video signal from the transmitter to a receiving station. The receiving station is located in a clean zone and has an electromagnetic radiation receiver receiving the video signal transmitted from the transmission station. A monitor in the clean zone receives the video signal from the receiving station and displays the live video image captured by the video camera in the hazardous zone.

In another aspect of the invention, the live reel is mounted on a rolling dolly whereby the live reel may be easily moved into the hazardous zone. The feed cable on the live reel will pay out to the transmission station as the live reel is moved. Further, a battery for supplying power to the video camera can be mounted on the rolling dolly.

In another aspect of the invention, the video camera, the feed cable, the battery pack are all electrically connected by electrical plugs so that one or more of the camera, the feed cable or the battery pack may be easily replaced.

These and various other features as well as advantages, which characterize the present invention, will be apparent from a reading of the following detailed description and a review of the associated drawings.

### BRIEF DESCRIPTION OF THE DRAWINGS

FIG. 1 shows a preferred embodiment of the video system of the present invention.

FIG. 2 shows a sealed video camera and its cable with connectors and mounting hardware and a power cable from a battery pack to the cable of the video camera.

FIG. 3A shows a sealed battery pack.

FIG. 3B shows the electrical connector for receiving the power plug at the battery pack.

FIG. 4 shows a live reel mounted on a two wheel dolly.

FIG. 5 shows a mount for the battery pack on the frame of the two wheel dolly and a mount for the camera and its cable on the frame of the dolly.

### DETAILED DESCRIPTION

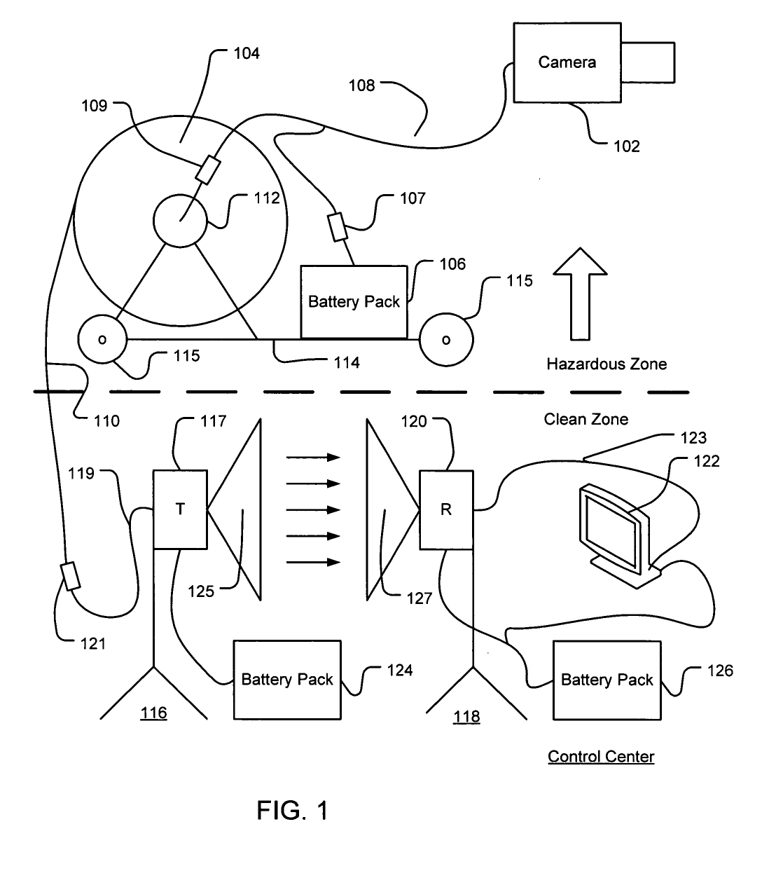

FIG. 1 shows one preferred embodiment for a video system in accordance with the present invention. A video camera 102 is electrically connected to a live reel 104 and a battery pack 106 by flexible camera cable 108. Camera cable 108 carries a video signal from the camera 102 and also carries DC power from the battery pack 106 to the camera 102. Connectors 107 and 109 for short cables at the battery pack 106 and at the live reel 104 are respectively an M-type plug for the power pack 106 and an RCA-type plug for the video cable 108.

The live reel 104 carries a large amount of feed cable 110. This cable could be any type of good signal cable including twisted pair or coax. Coax provides the least amount of signal loss for lengthy runs. Typically about 800 feet of coax cable 110 would be on the reel 104. Live reel 104 has a collector assembly hub 112. The collector assembly hub 112 provides electrical continuity between the camera cable 108 and the feed cable 110 on the live reel 104.

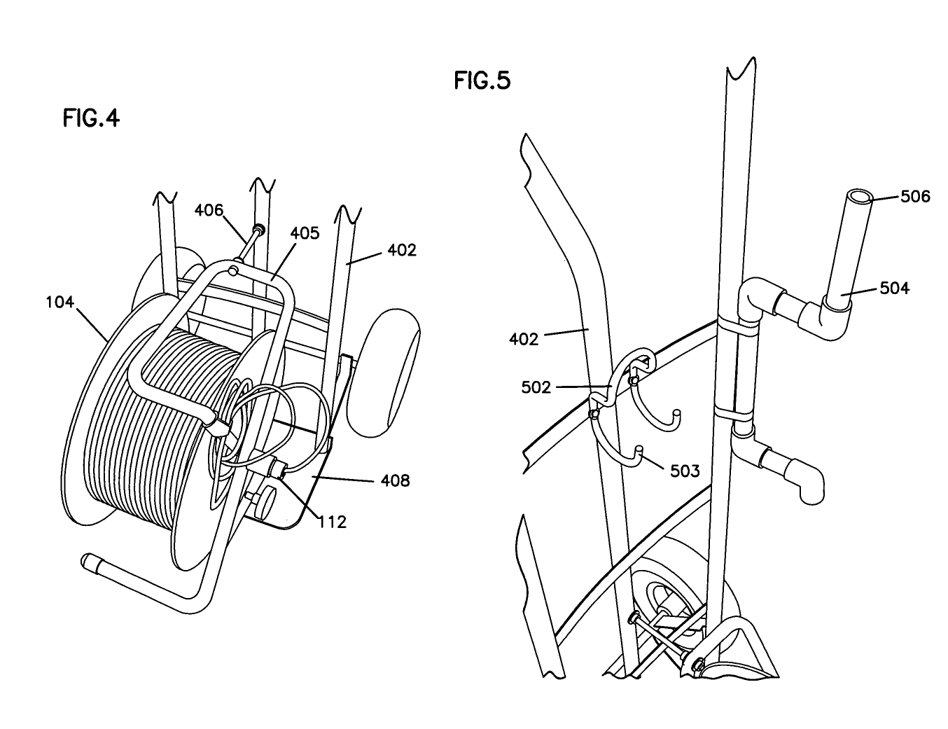

The live reel 104 and the battery pack 106 are carried on a dolly 114. Dolly 114 is roller mounted on wheels 115 so that it may be easily moved by a user of the video camera 102. The dolly 114 might be a two wheel dolly as depicted in FIGS. 4 and 5 or it might be a four wheel trolley as depicted in FIG. 1. In another embodiment, the trolley configuration could also be implemented as a remote-controlled, powered trolley with a remote-controlled camera mounted on the trolley.

The feed cable 110 from the live reel 104 is connected to a transmitter cable 119 at a transmission station 116. A video signal transmitted from the transmission station 116 is received at receiver station 118. The receiver station 118 passes the signal from a receiver 120 to monitor 122.

At the transmission station 116, transmitter 117 receives the video signal over the transmitter cable 119 through connector 121 connecting the transmitter cable 119 to the feed cable 110. The pluggable connector 121 is preferably an RCA plug. The transmitter 117 encodes the video signal for RF transmission. The RF signal is transmitted from transmission antenna 125. A sealed battery pack 124 at the transmission station 116 provides power to the transmitter 117.

At the receiving station 118, receiver antenna 127 receives the transmitted signal from transmission station 116. Receiver 120 decodes the transmitted signal, generates the video signal and passes the video signal to monitor 122 over receiver cable 123. A sealed battery pack 126 provides power to the receiver 120 and the monitor 122. Each of the battery packs 106, 124 and 126 are interchangeable so as to provide power redundancy in the system. Typically the receiving station 118 would have its own power supply, and its battery pack 126 would be used as backup for the other two battery packs 106, 124.

In operation, the system is connected up and the camera 102 turned on so that its image may be viewed at monitor 122. If everything is in working order, then a user in a hazardous material suit can pull the dolly 114 into the hazardous zone and carry the camera 102 or mount it on the dolly 114. The feed cable 110 would be physically attached at a rigid mount near the transmitting station 116. Thus, as the dolly 114 was pulled into the hazardous zone such as a building, feed cable 110 would pay out from the rotating live reel 104.

When the hazardous zone is inside a building, the transmission station 116 will be mounted outside the building. It is of course possible to mount the transmission station 116 in a select area in the building that has good electromagnetic radiation transmission characteristics. However, most buildings do not have good RF transmission characteristics, and in fact some rooms may be designed specifically to be hardened against radio frequency signals. Therefore, the transmission station 116 is probably best mounted outside of a building. Further, the transmission station 116 could also be mounted in the hazardous zone if there is not enough feed cable 110. However, this is not desirable as then the transmission station 116 must be decontaminated after its use. If decontamination is not possible, it would be disposed of and replaced.

As depicted in FIG. 1 in most configurations of the system, the dolly 114, live reel 104, battery pack 106, camera 102 and cables 108 and 110 will be in the hazardous or contaminated zone. Since the battery pack 106 and camera 102 are sealed they will likely be able to be decontaminated after the system has been used. Likewise, the live reel 104 can usually be decontaminated after its usage in a hazardous material zone. Feed cable 110 could be decontaminated but usually the expense of decontaminating the cable 110 is not worth the cost, and the feed cable 110 is usually replaced after use in a hazardous material zone.

FIG. 2 shows the sealed video camera 102 with its camera cable 108 and mounting hardware 204. Sealed video camera 102 is a Super-Mini: SM-50 B&W Camera available from Powerlynx, St. Petersburg, Fla. Mounting hardware 204 may be used to mount the camera 102 on a pistol grip for easy use by the user. This also allows proper orientation of the camera 102 on the pistol grip so that the user can simply point the camera 102.

The camera cable 108 includes a power cable and a video cable. The power cable terminates with an M-type connector 107B. The video cable of the camera cable 108 terminates with RCA plug 109.

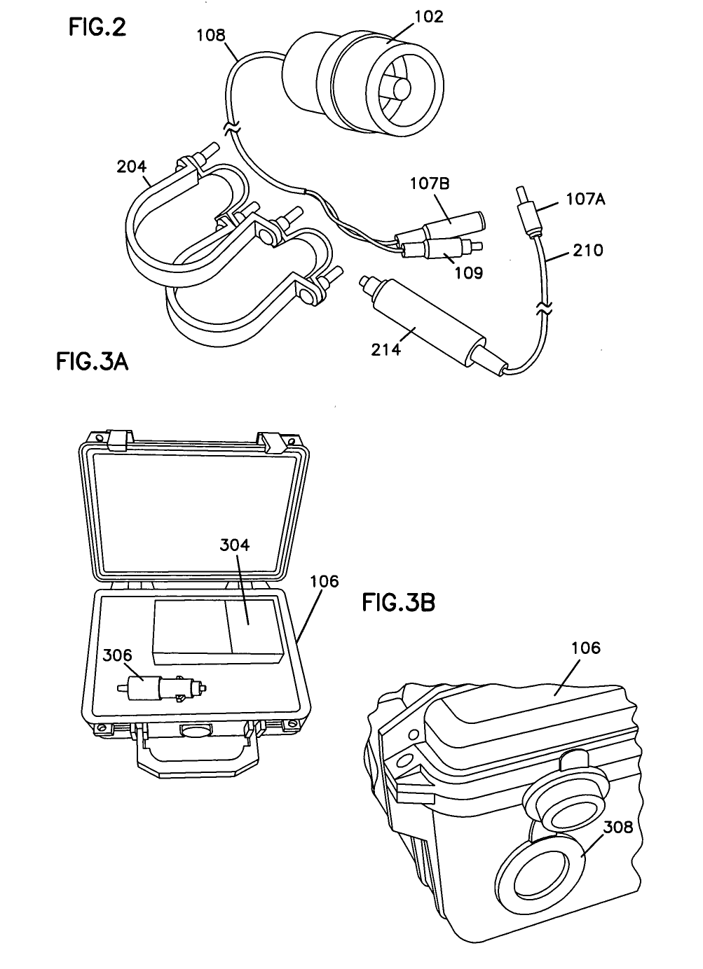

The power from the sealed battery pack 106 in FIG. 1 is provided over power cable 210. A power connector 107A on cable 210 is an M-type connector 107A and plugs into the M-type connector 107B on the camera cable 108. A power plug 214 is a cigarette lighter type plug and plugs into an outlet on the power pack shown in FIGS. 3A and 3B.

In FIG. 3A the sealed battery pack or power pack 106 is shown opened to display the battery 304 and a storage location for the power plug 214. A sealed power plug outlet 308 on the wall of the sealed power pack 106 is shown in FIG. 3B. The power plug 214 plugs into the power plug outlet 308. While other power packs might be used, the power pack 106 pictured in FIGS. 3A and 3B is Watersafe power pack available from Powerportstore.com. It is a water-tight sealed power pack, and thus can likely be decontaminated after use in a hazardous material zone.

FIG. 4 shows an embodiment of a two wheeled dolly. Frame 402 of the two wheel dolly has live reel 104 attached to the dolly. A live reel handle 405 is attached with bolt 406 to the frame 402 of dolly. A base of the reel 104 is bolted to plate 408 of the dolly. The feed cable 110 (FIG. 1) is shown wound on the live reel 104 and a connection from the collector assembly hub 112 is also shown in FIG. 4.

FIG. 5 shows the dolly frame 402 of the two wheel dolly in FIG. 4 with a hook assembly 502 to hold the battery pack 106 and a hanger assembly 504 to hold the camera 102 with its camera cable 108. Hook assembly 502 provides hooks 503 for hanging the battery pack in FIG. 3A by its handle on frame 402. The hanger assembly 504 in FIG. 5 provides a place to wind the camera cable 108. The camera 102, once a pistol grip is mounted on the bottom of the camera 102, can be mounted on the hanger assembly 504 by inserting the grip into the opening 506 of the hanger assembly 504. The hanger assembly 504 can be fabricated simply out of plastic and fastened to the frame 402, or it may be fashioned out of metal and welded or bolted to the frame 402.

In other embodiments the camera is a video/audio camera. A microphone is mounted with the camera and audio cables are added to the camera cable, feed cable, transmitter cable and receiver cable. Further, the transmitter 117 and receiver 120 could be connected by cable rather than using RF transmission through antennas 125 and 127.

It will be appreciated by one skilled in the art that there are also many variations on the dolly and other various components of the video system. It is important that each of the components be easily replaced and easily reconnected into the system—thus the use of readily available cables and pluggable connectors.

While the invention has been particularly shown and described with referenced to preferred embodiments thereof, it will be understood by those skilled in the art that various other changes in the form and details may be made therein without departing from the spirit and scope of the invention.

What is claimed is:

1. A live video system for providing live video monitoring of subject matter in a hazardous zone where the hazardous zone is located in a poor electromagnetic radiation transmission area, the live video monitoring being provided to a monitor outside the hazardous zone, the system comprising:
a video camera for being positioned in the hazardous zone, the camera being resistant to contamination and capturing video images of the subject matter;
the video camera for sending live video images over a camera cable;
a live reel for being placed in the hazardous zone with a feed cable on the live reel electrically connected to the camera cable as the feed cable is paid out from the live reel;
the feed cable extending from the live reel to a transmission station outside the poor electromagnetic radiation transmission area; and
the transmission station having a transmitter connected to the feed cable, receiving the video signal over the feed cable, and transmitting the video signal to a receiving station;
wherein a receiving station located in a clean zone and having an electromagnetic radiation receiver can receive the video signal transmitted from the transmission station and a monitor in the clean zone can receive the video signal from the receiving station and display the live video image captured by the video camera in the hazardous zone.

2. The live video system of claim 1 wherein the live reel is mounted on a rolling dolly whereby the live reel may easily be moved into the hazardous zone and the feed cable on the live reel will pay out to the transmission station as the live reel is moved.

3. The live video system of claim 2 further comprising:
a battery for supplying power to the video camera; and
the battery is mounted on the rolling dolly.

4. The live video system of claim 3 wherein the transmission station is located in the hazardous zone.

5. The live video system of claim 4 where each of the video camera, feed cable, battery pack are electrically connected by electrical plugs whereby one or more of the video camera, feed cable or battery pack may be replaced in the system.

6. The live video system of claim 1 wherein the video camera includes a microphone and sends video and audio signal for transmission to and monitoring at the monitor.

7. The live video system of claim 1 wherein the video camera is a sealed, underwater camera.

8. The live video system of claim 7 further comprising:
a battery pack for providing power to the video camera; and
the battery pack is a sealed underwater battery pack.

9. A live video system for providing live video monitoring of subject matter in a hazardous zone in a hardened radio frequency (RF) area, the system comprising:
a sealed video camera for being placed in the hazardous zone and the hardened RF area, the camera capturing video images of the subject matter in the zone;
a live reel with a feed cable on the live reel electrically connected to a camera cable connected to the camera, the electrical connection being continuous as the feed cable is paid out from the live reel; and
a transmission station located outside the hardened RF area having a RF transmitter connected to the feed cable, receiving the video signal over the feed cable, and transmitting the video signal;
wherein a receiving station located outside the hazardous zone having an RF receiver can receive the video signal transmitted from the transmission station and a monitor can receive the video signal from the receiving station and display the live video image captured by the video camera in the hazardous zone.

10. The live video system of claim 9 wherein the transmission station is also located outside of the hazardous zone.

11. The live video system of claim 9 wherein the live reel is located in the hazardous zone.

12. The live video system of claim 11 further comprising:
a sealed battery pack with the camera for providing power to the camera.

13. The live video system of claim 12 wherein the camera cable also includes a power cable connected to the sealed battery pack to provide power to the camera.

14. The live video system of claim 11 further comprising:
a dolly carrying the live reel and the sealed battery pack to move the live reel and sealed battery pack into the hazardous zone.
